(19) United States
(12) Patent Application Publication
(10) Pub. No.: US 2016/0071013 A1
(43) Pub. Date: Mar. 10, 2016

(54) Method for Estimating Optimal Power Flows in Power Grids using Consensus-Based Distributed Processing

(71) Applicant: Mitsubishi Electric Research Laboratories, Inc., Cambridge, MA (US)

(72) Inventors: Mouhacine Benosman, Boston, MA (US); Jie Liu, Notre Dame, IN (US); Arvind Raghunathan, Brookline, MA (US)

(21) Appl. No.: 14/482,003

(22) Filed: Sep. 10, 2014

(51) Int. Cl. G06N 5/04; G06N 7/00

(52) U.S. Cl. CPC G06N 5/04; G06N 7/00

(57) ABSTRACT

A method estimates an optimal power flows (OPF) in a power grid, which is represented as a graph partitioned into virtual sub-graphs, each including at least one bus, and associated with agents that measure local variables and updates consensus variables (CV). The consensus variables of adjacent virtual sub-graphs are exchanged and updated using the agents. An OPF problem is solved for the virtual sub-graphs using the agents based on the CV and the local variables. The exchanging and the solving are iterated until a termination condition is satisfied, when the optimal OPF is outputted for each virtual sub-graph.

### FIELD OF THE INVENTION

This invention relates generally to power grids, and more particularly to estimating power flows in power grids using distributed processing.

### BACKGROUND OF THE INVENTION

An electric power grid distributes power from generators to consumers (loads) via transmission lines and substations. An optimal power flow (OPF) is a key problem to solve in the operation of the grid. A solution to the OPF problem estimates active and reactive power generation and voltages of buses in the power grid to minimize a cost of power generation, under constraints of power generation limits, voltage limits and transmission line thermal limits. The OPF is crucial to a reliable operation of power grids.

The OPF is difficult to solve because the problem is nonconvex and nonlinear. In general, the nonconvexity, due a quadratic relations between voltages of adjacent buses, prevents a guarantee to a global optimal solution. The OPF is a large scale optimization problem with a large number of decision variables and constraints in power generation, voltages in all buses, and transmission line thermal limits. For practical implementations, the computational complexity of solving the problem needs to be reduced.

In practice, difficulties in solving the OPF are avoided by approximating a AC power flow problem by a DC-power flow problem, which is a linear programming problem. This approximation has an acceptable level of accuracy for transmission grids and is used by many independent system operators (ISO). However, the DC power flow solution is inaccurate for distribution grids, and cannot satisfy the requirements of smart grids, which include renewable energy sources, distributed power generation and storage.

Another approach uses a global optimal solution for the AC OPF problem based on semi-definite programming (SDP) relaxation. Even though the nonconvexity of the problem can be handled in several circumstances, centralized methods still cannot meet requirement of modern power grids. Due to the diverse, time-varying, and volatile load and storage connected to the grid, the solution of the centralized OPF problem should reflect any significant change in the power grid.

To satisfy the real-time requirements of the operation of the power grid, the OPF problem is usually solved every five minutes by power suppliers, such as regional transmission operators (RTO) and ISOs. As a result, the large scale OPF problem requires efficiency and accuracy that a centralized method cannot provide.

Hence, scalable, fast solution to large scale OPF problems use a distributed approach, where the OPF problem is partitioned into a number of small scale subproblems. Each subproblem is solved by a single agent as a computation entity with agent-to-agent communication capabilities. The agents exchange data according to a communication protocol. Thus, all agents participate in solving the OPF problem collaboratively and in a distributed manner.

In one distributed method, the power grid is partitioned into maximal cliques, see Lam et al. “Distributed algorithms for optimal power flow problem,” Decision and Control (CDC), IEEE 51st Annual Conference on, pages 430-437, 2012. That method solves the OPF problem with relaxed semi-definite programming (SDP) to convexify, i.e., approximate the problem. After SDP relaxation of the problem, that method uses an alternating direction method of multipliers (ADMM) to solve the convexified problem in a distributed way. The convexification approach, when it converges, is not guaranteed to provide a feasible point for the optimal power flow problem.

In another method, each bus is treated as an individual agent that maintains an estimate of voltages of adjacent buses, and formulates the reduced OPF problem by minimizing a local cost of power generation and an estimation error, see Dall'Anese et al. “Distributed optimal power flow for smart microgrids,” Smart Grid, IEEE Transactions on Volume: 4, Issue: 3, pp. 1464-1475, 2013. The local equality constraint for each agent is a power balance equation of each bus with the voltage variables of other buses replaced by estimates. The estimates converge to true values when the method reaches a feasible solution. That method also uses SDP relaxation and then uses a primal/dual algorithm for distributed optimization, which also cannot guarantee the feasibility point to the OPF problem.

Furthermore, the method only considers the case where the grids are modeled as trees, and both of those methods use a maximal clique decomposition. In both method, the graphs used to represent the power grid are limited to tree structures, and the graphs are decomposed to maximal cliques. The nodes and edges in the prior graphs and cliques only represent real physical components of the grid, e.g., actual buses and transmissions lines.

### SUMMARY OF THE INVENTION

The embodiments of the invention provide a method for estimating an optimal power flow (OPF) in a power grid using consensus-based distributed processing. The method is performed by agents where each agent is associated with at least one bus of the grid. Each agent is associated with local variables and consensus variables that are estimates for each of the local variables.

The local variables represent: its voltage and power variables; and estimates of voltage and power variables of its neighboring agents. The local variables are computed by the agent using a local optimization problem minimizing the cost of generation at the bus and the deviation of the local variables from their consensus variables. The optimization problem is subject to local power balance constraints representing the power flow on the line connecting the agent and its neighbors.

Each agent communicates to its neighboring agents: (i) its voltage and power and (ii) its consensus variable of its neighboring agent's voltage and power. Each agent applies a consensus filter to update its consensus variables. The process of optimization and communication is repeated until each agent's local variables and consensus variables have converged to within a tolerance.

The method represents the power grid as a graph, which is partitioned into virtual sub-graphs. Unlike the prior art, the vertices (also referred to as nodes) of the sub-graphs do not need to represent real physical components, i.e., buses associated with real physical generators and real loads. That is to say, the partitioning can generate virtual components from real components, i.e., virtual generators or virtual loads. This facilitates solving the OPF problem, e.g., when a single generator is connected to multiple loads, and the like, which cannot be handled by other approaches.

The method can use two different embodiments. In one embodiment, each virtual sub-graph includes only one bus which is associated with one agent. The agents share the voltages, and estimate the voltages of the neighboring buses that are connected by transmission lines.

In another embodiment, the virtual sub-graph includes at least two buses and each virtual sub-graph is associated with one agent. The power flow is only estimated for the buses connecting the virtual sub-graphs.

### BRIEF DESCRIPTION OF THE DRAWINGS

FIG. 1A is a block diagram of a bus and an associated agent in a power grid according to embodiments of the invention;

FIG. 1B is a block diagram of a method for estimating an optimal power flow (OPF) in a power grid using consensus-based distributed processing according to embodiments of the invention;

FIG. 1C is a block diagram of a network with three generators and a partitioning into two virtual sub-graphs according to embodiments of the invention;

FIG. 2 is a block diagram of a network with two generators and one load network and a partitioning into two virtual sub-graphs using a virtual generator and a virtual load according to embodiments of the invention;

FIG. 3 is a block diagram of a network with two generators and one load network and a partitioning into two virtual sub-graphs using two virtual loads according to embodiments of the invention;

FIG. 4 is a block diagram of a network with one generator and two loads and a partitioning into two virtual sub-graphs using a virtual load and a virtual generator according to embodiments of the invention;

FIG. 5 is a block diagram of the general case of solving the decentralized OPF problem that associates each virtual sub-graph with a local subOPF problem using a virtual sub-graph approach according to embodiments of the invention; and

FIG. 6 is a block diagram of a specific case of solving a decentralized OPF problem that associates each bus with a local subOPF problem using a direct approach according to embodiments of the invention.

### DETAILED DESCRIPTION OF THE PREFERRED EMBODIMENTS

The embodiments of the invention provide a method for an optimal power flow (OPF) in a power grid using consensus-based distributed processing.

Power Grid Representation

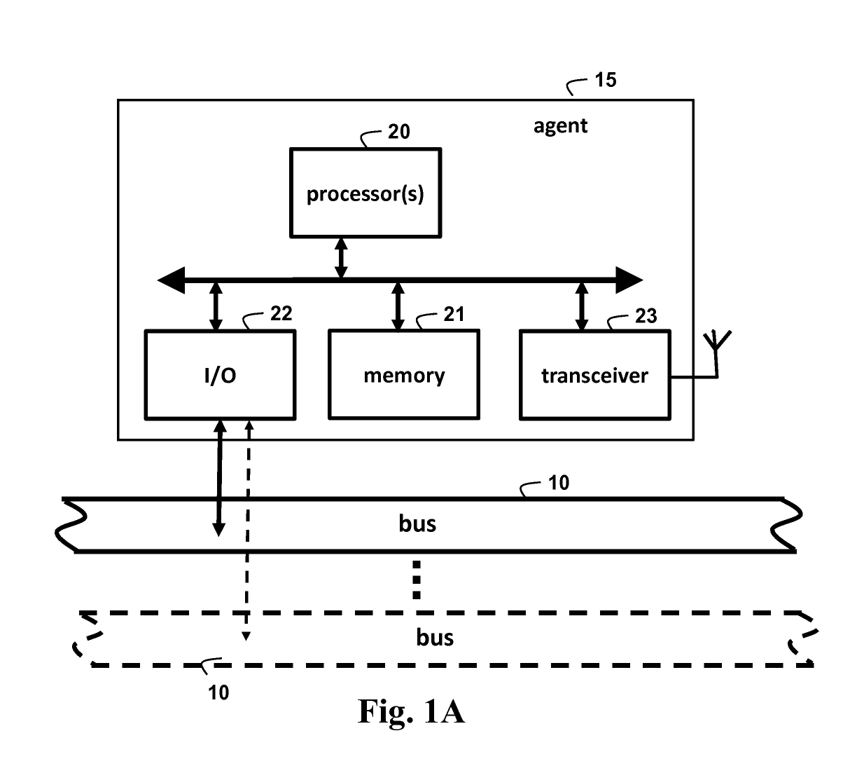

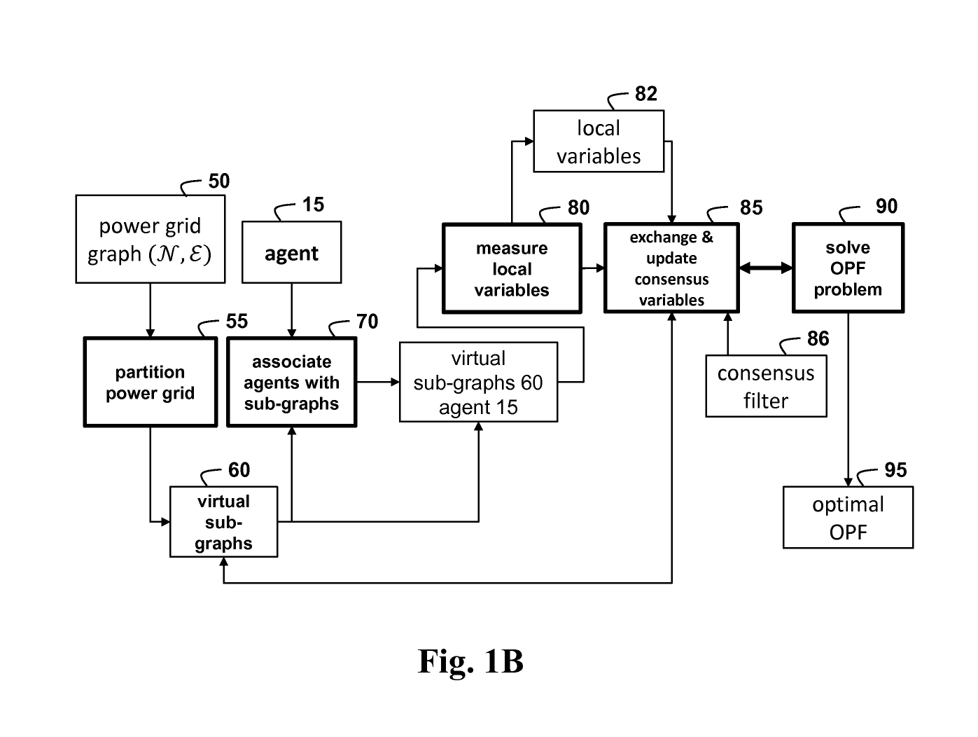

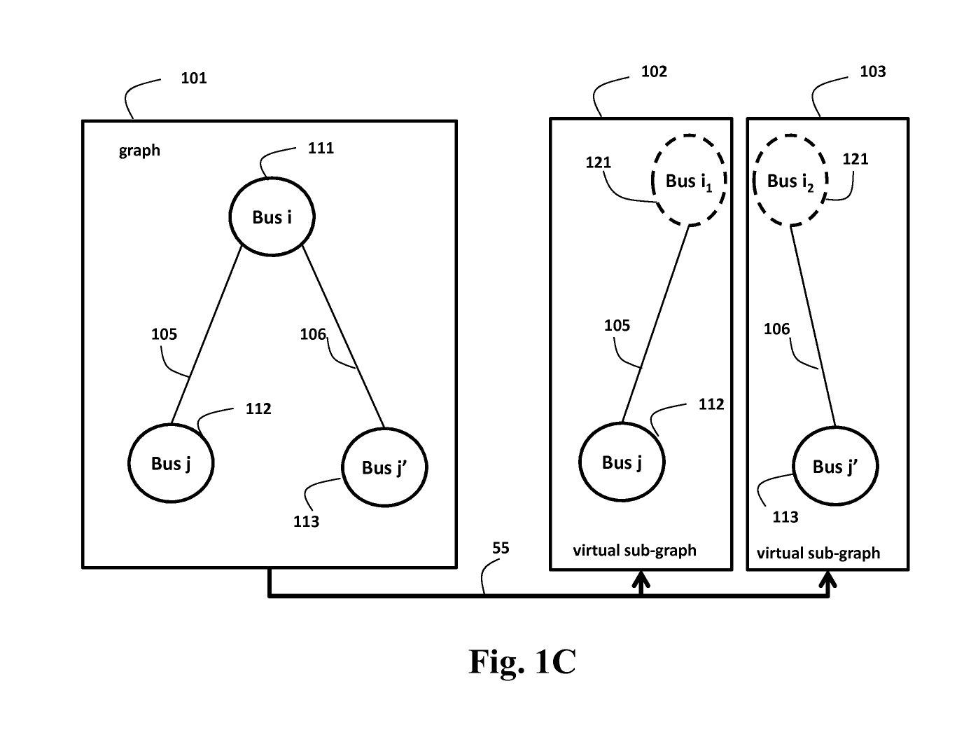

As shown in FIG. 1B, we model the power grid as a graph (N, E) 50, where a vertex set Nincludes all buses in the grid, and links ε between the vertices are overhead or underground transmission lines connecting the buses.

Each bus i εNcan be connected to generators or loads. The set of buses that are connected to generators is denoted as N^{G}⊂N. For convenience, a bus connected to a generator is called generator bus. A bus without any generators is a called load bus. We use i˜j to denote that the bus i is connected to bus j.

Active and reactive generation power at the bus i are denoted as Pᵢ^{G} and Qᵢ^{G}. The power demand at the bus i is denoted as Pᵢ^{D}, Qᵢ^{D}. A complex voltage of the bus i is denoted as Vᵢ=eᵢ+jfᵢ with eᵢ being a real part (Re) of the voltage, fᵢ an imaginary part (Im), and j=\sqrt{−1}. For simplicity, we refer to eᵢ and fᵢ collectively as Vᵢ. We denote the admittance-to-ground of bus i as yᵢᵢ. We denote the line admittance between buses i and j as yᵢⱼ. The admittances are complex numbers yᵢⱼ=gᵢⱼ+jbᵢⱼ. If i [symbol] j, then yᵢⱼ=0.

Optimal Power Flow (OPF) Problem

The OPF problem for all buses can be expressed as

$${min}_{{P}_{i}^{G} , {Q}_{i}^{G} , {e}_{i} , {f}_{i} , i ∈ 𝒩} {Σ}_{i ∈ {𝒩}^{G}} {F}_{i} ( {P}_{i}^{G} ) , \qquad ( 1 )$$

such that Pᵢ^{G}−Pᵢ^{D}=Re{|Vᵢ|²yᵢᵢ*+Σ_{i˜j}Vᵢyᵢⱼ*(Vᵢ−Vⱼ)*}, iεN, (2)

Qᵢ^{G}−Qᵢ^{D}=Im{|Vᵢ|²yᵢᵢ*+Σ_{i˜j}Vᵢyᵢⱼ*(Vᵢ−Vⱼ)*}, iεN, (3)

Vᵢ≦eᵢ²+fᵢ²≦ V̅ᵢ, iεN, and (4)

Pᵢ^{G}≦Pᵢ^{G}≦ P̅ᵢ^{G},Qᵢ^{G}≦Qᵢ^{G}≦ Q̅ᵢ^{G}, iεN^{G}, (5)

where a cost function Fᵢ can be expressed as a quadratic equation

Fᵢ(Pᵢ^{G})=c_{2,i}(Pᵢ^{G})²+c_{1,i}Pᵢ^{G},

where c_{1,i}, c_{2,i} are predetermined positive constants.

Equations (2) and (3) are real and reactive power balance equations for the bus i. The inequality in equation (4) is the upper and lower bound on the magnitude of the voltages. The inequality in equation (5) is a bound on the real and reactive generation power.

The nonconvexity of the OPF comes from the quadratic relationships between the voltages in power balance equations (2) and (3). This makes it difficult to solve the OPF problem. In addition, the number of the buses in the grid is often too large to solve the OPF in a centralized manner.

Therefore, we describe a distributed method to solve the OPF problem in equation (1). Our method has two variations. In one embodiment, each bus is associated with one agent. In another embodiment, the graph representation of the power grid is partitioned into virtual sub-graphs, and each virtual sub-graph has one bus and is associated with one agent. However, we note that unlike the prior art, we still solve the nonconvex problem directly. In addition, instead of using an ADMM to solve the problem we use a formulation that includes a penalty.

Direct Approach for Consensus-Based Distributed Power Flow Estimation

As shown in FIG. 1A for one embodiment, each bus 10 in a power grid is associated with one agent 15. In another embodiment, described below, the agent is associated with two buses or more.

Each agent includes computation and communication capabilities. For example, the agent can include a processor 20 connected to memory 21, input/output (I/O) interfaces 22 and a transceiver 23. The processor can be a multicore processor, a microprocessor, a parallel processor, and the like.

FIG. 1B show a block diagram of the general method for estimating an optimal power flow (OPF) in a power grid using consensus-based distributed processing.

The power grid represented by the graph (N, E) 50 is partitioned 55 into virtual sub-graphs 60. Each virtual sub-graph includes at least bus 10. The agent 15 is associated 70 with the virtual sub-graphs 60. The graph and sub-graph can be store in the memory.

The agent measures 80 local variables 82 and updates 85 consensus variables in the virtual sub-graph using the processor and the I/O interfaces.

The local variables include voltage and power variables. If the bus of the agent bus and those of the buses that are adjacent to the bus, then the consensus variables of the local variables are also stored by the agent. The local variables are subject to power balance constraints in the virtual sub-graph. The deviation of the local variables from the consensus variables are penalized in the objective using a penalty function. The variables can be stored in the memory.

The agent exchanges 85 the local variables between the virtual sub-graphs 60 using the transceiver. The consensus variables are updated by applying the consensus filter 86.

The OPF problem for the sub-graph is solved 90 using the agent based on the local variables and updated consensus variables. The exchanging, updating and the solving iterates until a termination condition is satisfied, and the optimal OPF 95 for the virtual sub-graph is output.

For simplicity in the description, we do not distinguish between the agent 14 and the bus(es) 10, unless there is a particular need to do so.

We formulate the OPF problem as multiple subproblems, and each subproblem is solved by the corresponding agent. For simplicity, we assume that all buses are connected to a generator, i.e., N^{G}=N. For each bus i, we formulate a local subproblem of the OPF. The local decision variables at the bus i are Pᵢ^{G}, Qᵢ^{G}, eᵢ, fᵢ. Note that there are constrained couplings of the voltage in the power balance equations between the bus i and adjacent bus j, as expressed in equations (2) and (3). Thus, while solving the optimization problem, the bus i estimates the voltages of the adjacent bus j, which are denoted as eⱼ₍ᵢ₎, fⱼ₍ᵢ₎. The voltage Vⱼ₍ᵢ₎=eⱼ₍ᵢ₎+jfⱼ₍ᵢ₎ represents the complex voltage of bus j˜i estimated by the bus i. The estimates are used to replace the real voltages of bus j in the power balance equations of the bus i. Those estimates are also part of the decision variables for the bus i.

Local OPF Problem

The local OPF problem for bus i can be expressed as follows.

$${min}_{{P}_{i}^{G} , {Q}_{i}^{G} , {e}_{i} , {f}_{i} , {e}_{j ( i )} , {f}_{j ( i )}} {{c}_{i , 2} ( {P}_{i}^{G} )}^{2} + {c}_{i , 1} {P}_{i}^{G} , \qquad ( 6 )$$

s.t.Pᵢ^{G}−Pᵢ^{D}=Re{|Vᵢ|²yᵢᵢ*+Σ_{i˜j}Vᵢyᵢⱼ*(Vᵢ−Vⱼ₍ᵢ₎)*}, iεN, (7)

Qᵢ^{G}−Qᵢ^{D}=Im{|Vᵢ|²yᵢᵢ*+Σ_{i˜j}Vᵢyᵢⱼ*(Vᵢ−Vⱼ₍ᵢ₎)*}, iεN, (8)

Vᵢ≦eᵢ²+fᵢ²≦ V̅ᵢ, (9)

Vⱼ₍ᵢ₎≦eⱼ₍ᵢ₎²+fⱼ₍ᵢ₎²≦ V̅ⱼ₍ᵢ₎, jεN/i, (10)

Pᵢ^{G}≦Pᵢ^{G}≦ P̅ᵢ^{G},Qᵢ^{G}≦Qᵢ^{G}≦ Q̅ᵢ^{G}, iεN^{G}, and (11)

Vⱼ=Vⱼ₍ᵢ₎, i˜j, i εN, (12)

where the constraint in equation (12) ensures that the estimate of the voltage of bus j formed at the bus i is consistent with the true value Vⱼ.

To solve the local OPF problem in equation (6), each bus i minimizes the generation cost, and the estimates eⱼ₍ᵢ₎, fⱼ₍ᵢ₎ follow the real voltages eⱼ, fⱼ, i.e., the constraint in equation (12) is satisfied. The generation cost is included in the local OPF problem in equation (6).

Consensus Method of the Estimates

For each pair of real local voltages eⱼ₍ᵢ₎, fⱼ₍ᵢ₎, the bus i maintains a pair of consensus variables êⱼ₍ᵢ₎, \hat{f}ⱼ₍ᵢ₎ and updates these variables using the real local value of eⱼ, fⱼ obtained from the bus j by applying following consensus filter:

êⱼ₍ᵢ₎(k+1)=êⱼ₍ᵢ₎(k)+γ(eⱼ(k)−êⱼ₍ᵢ₎(k)), (13)

\hat{f}ⱼ₍ᵢ₎(k+1)=\hat{f}ⱼ₍ᵢ₎(k)+γ(fⱼ(k)−\hat{f}ⱼ₍ᵢ₎(k)), and

where 0<γ<1 is a consensus gain.

That is an estimate of the value of an updated consensus variable at the iteration (k+1) is a sum of the estimate of the previous value at the iteration (k), and a difference (between the previous real value and the previous estimated value) multipled by the consensus gain.

In our method, the estimates, such as eⱼ₍ᵢ₎ and fⱼ₍ᵢ₎ are not replaced by true values from other buses directly, such as eⱼ, fⱼ. Instead, the values are passed through the consensus filter. The consensus variables can be viewed as intermediate variables in the filter and are used to update the estimates in the local optimization.

The buses i and j exchange the real voltages and their consensus variables at each iteration k. In other words, the bus i receives the true voltage eⱼ(k), fⱼ(k) and the consensus variables êᵢ₍ⱼ₎, \hat{f}ᵢ₍ⱼ₎, and exchanges voltage eᵢ(k), fᵢ(k) and the consensus variables êⱼ₍ᵢ₎, \hat{f}ⱼ₍ᵢ₎ to adjacent buses. Because the exchange only occurs among the adjacent buses, the additional burden in communication overhead, when compared to the centralized method that requires all data from every bus are acquired and processed by a single processing center, is slight.

Local Optimization Problem

To minimize both the generation cost and estimation error, the local optimization problem in equation (6) is reformulated. For bus i εN, the local optimization problem is expressed as

$$i . {min}_{{P}_{i}^{G} , {Q}_{i}^{G} , {e}_{i} , {f}_{i} , {e}_{j ( i )} , {f}_{j ( i )}} {F}_{i} ( {P}_{i}^{G} ) + {ρ}_{i} {Σ}_{i ∼ j} ( {‖ {e}_{j ( i )} - {\hat{e}}_{j ( i )} ‖}^{2} + {‖ {f}_{j ( i )} - {\hat{f}}_{j ( i )} ‖}^{2} + {‖ {e}_{i} - {\hat{e}}_{i ( j )} ‖}^{2} + {‖ {f}_{i} - {\hat{f}}_{i ( j )} ‖}^{2} ) , \qquad ( 14 )$$

s.t.Pᵢ^{G}−Pᵢ^{D}=Re{|Vᵢ|²yᵢᵢ*+Σ_{i˜j}Vᵢyᵢⱼ*(Vᵢ−Vⱼ₍ᵢ₎)*}, iεN, (15)

Qᵢ^{G}−Qᵢ^{D}=Im{|Vᵢ|²yᵢᵢ*+Σ_{i˜j}Vᵢyᵢⱼ*(Vᵢ−Vⱼ₍ᵢ₎)*}, iεN, (16)

Vᵢ≦eᵢ²+fᵢ²≦ V̅ᵢ,and (17)

Vⱼ₍ᵢ₎≦eⱼ₍ᵢ₎²+fⱼ₍ᵢ₎²≦ V̅ⱼ₍ᵢ₎, jεN/iPᵢ^{G}≦Pᵢ^{G}≦ P̅ᵢ^{G},Qᵢ^{G}≦Qᵢ^{G}≦ Q̅ᵢ^{G}, iεN. (18)

where ρᵢ>0 is a large positive penalty factor to make sure that the estimation errors are minimized with a higher priority. This is necessary, because without such a penalty, each bus may minimize its own generation cost selfishly based on a set of biased estimation.

The decision variables of the problem in equation (14) are only related to the bus i and adjacent buses so the problem is a local nonlinear optimization problem with a relatively small scale. This problem can be solved efficiently using nonlinear programming solvers, such as Interior Point OPTimizer (IPOPT) or a “find minimum of constrained nonlinear multivariable function” (fmincon).

We can summarize the distributed estimation method for bus i as follows.

(1) initialize variables:
Pᵢ^{G} (0), Qᵢ^{G}(0), eᵢ(0), fᵢ(0), eⱼ₍ᵢ₎(0), fⱼ₍ᵢ₎(0),êⱼ₍ᵢ₎ (0), \hat{f}ⱼ₍ᵢ₎(0)

(2) At iteration k+1, if when a termination condition is satisfied, end. Otherwise, each agent exchanges the variables eᵢ(k), fᵢ(k), êⱼ₍ᵢ₎(k), \hat{f}ⱼ₍ᵢ₎(k) to adjacent buses j˜i.

(3) Update the consensus variables êⱼ₍ᵢ₎(k), \hat{f}ⱼ₍ᵢ₎(k) as in equation (13).

(4) Update the decision variables by solving the optimization problem in equation (14), i.e.,

Pᵢ^{G}(k+1),Qᵢ^{G}(k+1),eᵢ(k+1),fᵢ(k+1),eⱼ₍ᵢ₎(k+1),fⱼ₍ᵢ₎(k+1)=argmin Fᵢ(Pᵢ^{G}(k))+ρᵢΣ_{i˜j}(∥eⱼ₍ᵢ₎₍ₖ₎−êⱼ₍ᵢ₎₍ₖ₎∥²+∥fⱼ₍ᵢ₎₍ₖ₎−\hat{f}ⱼ₍ᵢ₎₍ₖ₎∥²+∥eᵢ(k)−êᵢ₍ⱼ₎(k)∥²+∥fᵢ(k)−\hat{f}ᵢ₍ⱼ₎(k)∥²). (19)

Then, go to step (2).

In another embodiment, the penalty in the objective function of the local optimization problem can be formulated using the 1-norm as,

Fᵢ(Pᵢ^{G})+ρᵢΣ_{i˜j}(|eⱼ₍ᵢ₎−êⱼ₍ᵢ₎|+|fⱼ₍ᵢ₎−\hat{f}ⱼ₍ᵢ₎|+|eᵢ−êᵢ₍ⱼ₎|+|fᵢ−\hat{f}ᵢ₍ⱼ₎|),

This method works well for solving the case when all buses are generator buses. However, for grids with load buses, the method can be sensitive to the initial values and often has a steady state estimation error for the load bus. This problem is caused by the lack of degree of freedom in the load bus. To solve this problem, we use consensus filtering for the virtual sub-graphs.

Consensus-Like Distributed Optimization Method Based on Virtual Sub-Graphs

This embodiment solves the problem when there is a load bus in the grid. We partition the power grids into virtual sub-graphs. In one embodiment, each virtual sub-graph is concerned with the power flow between two buses. The virtual sub-graph is associated with an agent, which performs the distributed method is a similar manner as the direct approach described above.

Virtual Sub-Graphs

FIG. 1C shows graph 101 with bus i 111, bus j and bus j′ connected by lines 105 and 106 respectively. The partitioning 55 splits the graph 101 into virtual sub-graph 102 and 103. That is, the real bus i is split into two virtual buses, e.g., bus iᵢ and bus i₂ 121. Virtual components are shown as dashed lines. If the bus i 111 is a generator bus and the bus j is a load bus, then the virtual sub-graphs are concerned with the power flow from the bus i to bus j, where the power flow between bus i and bus j and the power flow between bus i and j′ are connected according to the two virtual sub-graphs 102 and 103.

There are three types virtual sub-graphs:

Case 1: one generator bus and one load bus;

Case 2: two generator buses; and

Case 3: two load buses.

### (1) One Generator Bus and One Load Bus

P_{i|(i,j)}^{G}−P_{i|(i,j)}^{D}=Re{|V_{i|(i,j)}|²yᵢᵢ*/Nᵢ+V_{i|(i,j)}yᵢⱼ*(V_{i|(i,j)}−V_{j|(i,j)})*}, (20)

Q_{i|(i,j)}^{G}−Q_{i|(i,j)}^{D}=Im{|V_{i|(i,j)}|²yᵢᵢ*/Nᵢ+V_{i|(i,j)}yᵢⱼ*(V_{i|(i,j)}−V_{j|(i,j)})*}, (21)

−P_{i|(i,j)}^{D}=Re{|V_{j|(i,j)}|²yᵢᵢ*/Nᵢ+V_{i|(i,j)}yᵢⱼ*(V_{i|(i,j)}−V_{j|(i,j)})*},and (22)

−Q_{j|(i,j)}^{D}=Im{|V_{j|(i,j)}|²yᵢᵢ*/Nᵢ+V_{i|(i,j)}yᵢⱼ*(V_{i|(i,j)}−V_{j|(i,j)})*}, (23)

where Nᵢ is the number of the adjacent buses of the bus i. Note that the power terms P_{i|(i,j)}^{G}, P_{i|(i,j)}^{D} and the voltages V_{i|(i,j)}, V_{j|(i,j)} are local variables maintained by the virtual sub-graph. In particular, the voltage V_{i|(i,j)} is the voltage of the bus i estimated by the virtual sub-graph (i,j). The voltage is only an estimate because another virtual sub-graph may also include the bus i and determine its own estimate. To ensure consistent estimates of the same variable, the following conditions are imposed on the variables.

Σ_{j˜i}P_{i|(i,j)}^{G}=Pᵢ^{G}, Σ_{j˜i}Q_{i|(i,j)}^{G}=Qᵢ^{G}, (24)

Σ_{i˜j}P_{i|(i,j)}^{D}=Pᵢ^{D}, Σ_{i˜j}Q_{i|(i,j)}^{D}=Qᵢ^{D},and (25)

V_{i|(i,j)}=Vᵢ,V_{j|(i,j)}=Vⱼ,∀j˜i. (26)

The local variables of powers, such as P_{i|(i,j)}^{G}, P_{i|(i,j)}^{D}, can be interpreted as the portion of power involved in the branch flow for the virtual sub-graph (i,j). In other words, we partition the real power generation or load into several parts, and assign each part to a different virtual sub-graph. Therefore, the sum of those local variables, such as generation power P_{i|(i,j)}^{G}, must be equal to the real value of the power generation at the bus i, as imposed in the condition in equation (24).

### (2) Two Generator Buses

A generator bus can also have a directly attached load. Thus, it is flexible to model the generator bus as a load bus or a generator bus in the virtual sub-graph. The modelling can be different for various cases. In the situation of a virtual sub-graph with two generator buses connected to each other, there are two cases to consider.

In the first case, the generator bus does not have sufficient power to support a connected load or the load buses in adjacent virtual sub-graphs. In this case, the generator bus can be modelled as a load bus in the virtual sub-graph with another generator bus that supplies the needed power, which is also modeled as a generator bus in the virtual sub-graph that includes the load.

For two generator buses i₁ and i₂, we can assume that the power flow is from bus i₁ to bus i₂. Therefore, we model the bus i₂ as a load bus. The flow equations can be expressed as

Pᵢ_{₁}_{|(i}_{₁}_{,i}_{₂}₎^{G}−Pᵢ_{₁}_{|(i}_{₁}_{,i}_{₂}₎^{D}=Re{|Vᵢ_{₁}_{|(i}_{₁}_{,i}_{₂}₎|²yᵢ_{₁}ᵢ_{₁}*/Nᵢ_{₁}+Vᵢ_{₁}_{|(i}_{₁}_{,i}_{₂}₎yᵢ_{₁}ᵢ_{₂}*(Vᵢ_{₁}_{|(i}_{₁}_{,i}_{₂}₎−Vᵢ_{₂}_{|(i}_{₁}_{,i}_{₂}₎)*}, (27)

Qᵢ_{₁}_{|(i}_{₁}_{,i}_{₂}₎^{G}−Qᵢ_{₁}_{|(i}_{₁}_{,i}_{₂}₎^{D}=Im{|Vᵢ_{₁}_{|(i}_{₁}_{,i}_{₂}₎|²yᵢ_{₁}ᵢ_{₁}*/Nᵢ_{₁}+Vᵢ_{₁}_{|(i}_{₁}_{,i}_{₂}₎yᵢ_{₁}ᵢ_{₂}*(Vᵢ_{₁}_{|(i}_{₁}_{,i}_{₂}₎−Vᵢ_{₂}_{|(i}_{₁}_{,i}_{₂}₎)*}, (28)

−Pᵢ_{₂}_{|(i}_{₁}_{,i}_{₂}₎^{D}=Re{|Vᵢ_{₂}_{|(i}_{₁}_{,i}_{₂}₎|²yᵢ_{₂}ᵢ_{₂}*/Nᵢ_{₂}+j{Vᵢ_{₂}_{|(i}_{₁}_{,i}_{₂}₎yᵢ_{₂}ᵢ_{₁}*(Vᵢ_{₂}_{|(i}_{₁}_{,i}_{₂}₎−Vᵢ_{₁}_{|(i}_{₁}_{,i}_{₂}₎)*},and (29)

−Qᵢ_{₂}_{|(i}_{₁}_{,i}_{₂}₎^{D}=Im{{|Vᵢ_{₂}_{|(i}_{₁}_{,i}_{₂}₎|²yᵢ_{₂}ᵢ_{₂}*/Nᵢ_{₂}+Vᵢ_{₂}_{|(i}_{₁}_{,i}_{₂}₎yᵢ_{₂}ᵢ_{₁}*(Vᵢ_{₂}_{|(i}_{₁}_{,i}_{₂}₎−Vᵢ_{₁}_{|(i}_{₁}_{,i}_{₂}₎)*}. (30)

Note that the load Pᵢ_{₂}_{,|(i}_{₁}_{,i}_{₂}₎^{D} of the bus i₂ can be viewed as a virtual load that consumes the power flow from the bus i₂. This implies that the value of Pᵢ_{₂}_{,|(i}_{₁}_{,i}_{₂}₎^{D} can exceed the real load Pᵢ_{₂}^{D}. This happens when the part of grid beyond bus j may need the power of bus i₁ that is supplied through bus i₂. The bus i₂ must also appear as a generator bus in other virtual sub-graphs for consistency.

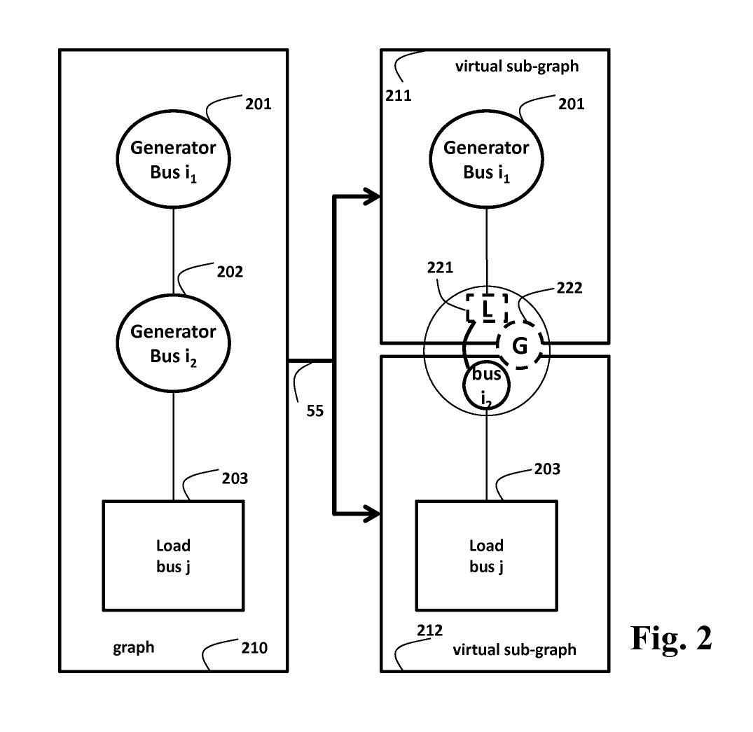

FIG. 2 shows a graph 210 representing a grid including a generator bus i₁ 201, a generator bus i₂ 202, and a load bus j 203. We use circles to represent the generator buses and a square to represent the load bus. The graph 210 is partitioned 55 into two virtual sub-graphs 211 and 212. Then, in the virtual sub-graph 212 the bus i₂ is then seen as being connected to a virtual load 221 with real and reactive power defined as P_{v,i}_{₂}_{|(i}_{₁}_{,i}_{₂}₎^{D}, Q_{v,i}_{₂}_{|(i}_{₁}_{,i}_{₂}₎^{D}. In the virtual sub-graph 212, the bus i₂ is then seen as being connected to a virtual generator 222.

Accordingly, in the virtual sub-graph (i₂, j) 212, there is a virtual generation power term P_{v,i}_{₂}_{|(i}_{₁}_{,i}_{₂}₎^{G}, P_{v,i}_{₂}_{|(i}_{₁}_{,i}_{₂}₎^{G} associated with the virtual generator 222, such that P_{v,i}_{₂}_{|i}_{₁}_{,i}_{₂}^{G}=P_{v,i}_{₂}_{|(i}_{₁}_{,i}_{₂}₎^{D} and Q_{v,i}_{₂}_{|i}_{₁}_{,i}_{₂}^{G}=Q_{v,i}_{₂}_{|(i}_{₁}_{,i}_{₂}₎^{D}.

FIG. 2 shows an example of virtual sub-graphs with two generator buses. In a first case, the power balance equations of the virtual sub-graph (i₂, j) can be expressed as

Pᵢ_{₂}₍ᵢ_{₂}_{,j)}^{G}+P_{v,i}_{₂}_{|(i}_{₂}_{,j)}^{G}−Pᵢ_{₂}_{|(i}_{₂}_{,i}_{₂}₎^{D}=Re{|Vᵢ_{₂}_{|(i}_{₂}_{,j)}|²yᵢ_{₂}ᵢ_{₂}*/Nᵢ_{₂}+Vᵢ_{₂}_{|(i}_{₂}_{,j)}yᵢ_{₂}_{,j}*(Vᵢ_{₂}_{|i}_{₂}_{,j)}−V_{j|(i}_{₂}_{,j)})*}, (31)

Qᵢ_{₂}_{|(i}_{₂}_{,j)}^{G}+Q_{v,i}_{₂}_{|(i}_{₂}_{,j)}^{G}−Qᵢ_{₂}_{|(i}_{₂}_{,j)}^{D}=Im{|Vᵢ_{₂}_{|(i}_{₂}_{,j)}|²yᵢ_{₂}ᵢ_{₂}*/Nᵢ_{₂}+Vᵢ_{₂}_{|(i}_{₂}_{,j)}yᵢ_{₂}_{,j}*(Vᵢ_{₂}_{|i}_{₂}_{,j)}−V_{j|(i}_{₂}_{,j)})*}, (32)

−P_{j|(i}_{₂}_{,j)}^{D}=Re{|V_{j|(i}_{₂}_{,j)}|²y_{j,j}*/Nⱼ+V_{j|(i}_{₂}_{,j)}y_{j,i}_{₂}*(V_{j|(i}_{₂}_{,j)}−Vᵢ_{₂}_{|(i}_{₂}_{,j)})*}, (33)

−Q_{j|(i}_{₂}_{,j)}^{D}=Im{|V_{j|(i}_{₂}_{,j)}|²y_{j,j}*/Nⱼ+V_{j|(i}_{₂}_{,j)}y_{j,i}_{₂}*(V_{j|(i}_{₂}_{,j)}−Vᵢ_{₂}_{|(i}_{₂}_{,j)})*}. (34)

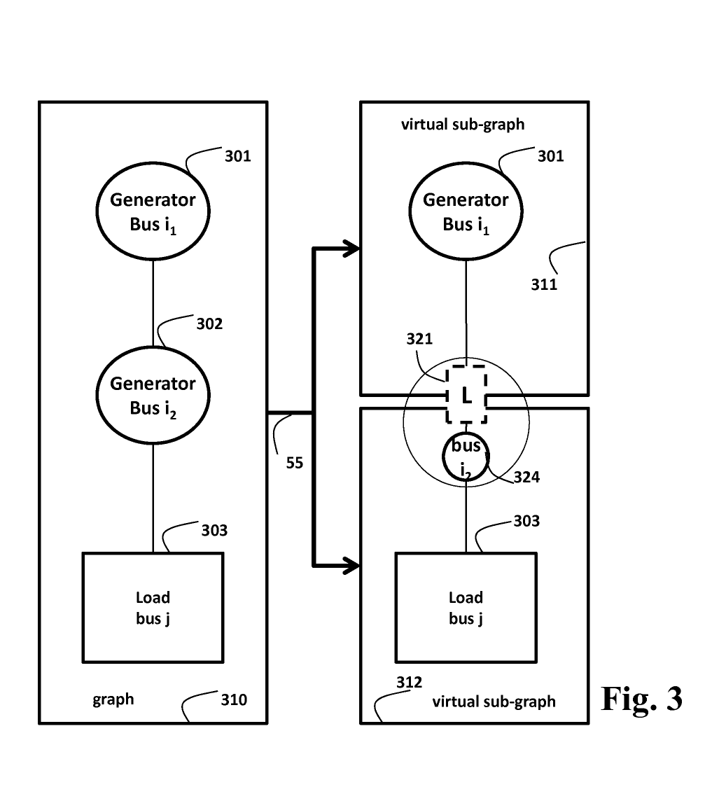

The second case showed on FIG. 3, is that two generator buses share the load of one of the buses, such that bus i₁ 301 and bus i₂ 302 supply the power to the load at bus j 303. In this case, the virtual sub-graph can be formed by viewing the bus i₂ 302 as a load bus in virtual sub-graph (i₁, i₂) 311, with part of the load at bus i₂ 321 defined such that Pᵢ_{₂}_{|(i}_{₁}_{,i}_{₂}₎^{D}<Pᵢ_{₂}^{D}. The rest of the load can appear in other virtual sub-graph, where bus i₂ is viewed as a generator bus 324.

### (3) Two Load Buses

For a virtual sub-graph that contains two load buses j₁ 402 and j₂ 403, the power flow is from bus jᵢ to bus j₂. We assume that there is a virtual generator connected to bus jᵢ 422, which supplies power Pⱼ_{₁}_{,j}_{₂}^{G}. We can write the power flow equation as

Pⱼ_{₁}_{|(j}_{₁}_{,j}_{₂}₎^{G}=Re{|Vⱼ_{₁}_{|(j}_{₁}_{,j}_{₂}₎|²yⱼ_{₁}_{,j}_{₁}*/Nⱼ_{₁}+Vⱼ_{₁}_{|(j}_{₁}_{,j}_{₂}₎yⱼ_{₁}_{,j}_{₂}*(Vⱼ_{₁}_{|(j}_{₁}_{,j}_{₂}₎−Vⱼ_{₂}_{|(j}_{₁}_{,j}_{₂}₎)*}, (35)

Qⱼ_{₁}_{|(j}_{₁}_{,j}_{₂}₎^{G}=Im{|Vⱼ_{₁}_{|(j}_{₁}_{,j}_{₂}₎|²yⱼ_{₁}_{,j}_{₁}*/Nⱼ_{₁}+Vⱼ_{₁}_{|(j}_{₁}_{,j}_{₂}₎yⱼ_{₁}_{,j}_{₂}*(Vⱼ_{₁}_{|(j}_{₁}_{,j}_{₂}₎−Vⱼ_{₂}_{|(j}_{₁}_{,j}_{₂}₎)*}, (36)

−Pⱼ_{₂}_{|(j}_{₁}_{,j}_{₂}₎^{D}=Re{|Vⱼ_{₂}_{|(j}_{₁}_{,j}_{₂}₎|²yⱼ_{₂}_{,j}_{₂}*/Nⱼ_{₂}+Vⱼ_{₂}_{|(j}_{₁}_{,j}_{₂}₎yⱼ_{₂}_{,j}_{₁}*(Vⱼ_{₂}_{|(j}_{₁}_{,j}_{₂}₎−Vⱼ_{₁}_{|(j}_{₁}_{,j}_{₂}₎)*}, (37)

−Qⱼ_{₂}_{|(j}_{₁}_{,j}_{₂}₎^{D}=Im{|Vⱼ_{₂}_{|(j}_{₁}_{,j}_{₂}₎|²yⱼ_{₂}_{,j}_{₂}*/Nⱼ_{₂}+Vⱼ_{₂}_{|(j}_{₁}_{,j}_{₂}₎yⱼ_{₂}_{,j}_{₁}*(Vⱼ_{₂}_{|(j}_{₁}_{,j}_{₂}₎−Vⱼ_{₁}_{|(j}_{₁}_{,j}_{₂}₎)*}. (38)

Note that a virtual generation term Pⱼ_{₁}_{|(j}_{₁}_{,j}_{₂}₎^{G} appears in a generator bus 401 that is connected to the bus jᵢ as a virtual load 402. This can maintain the power balance of the power grid.

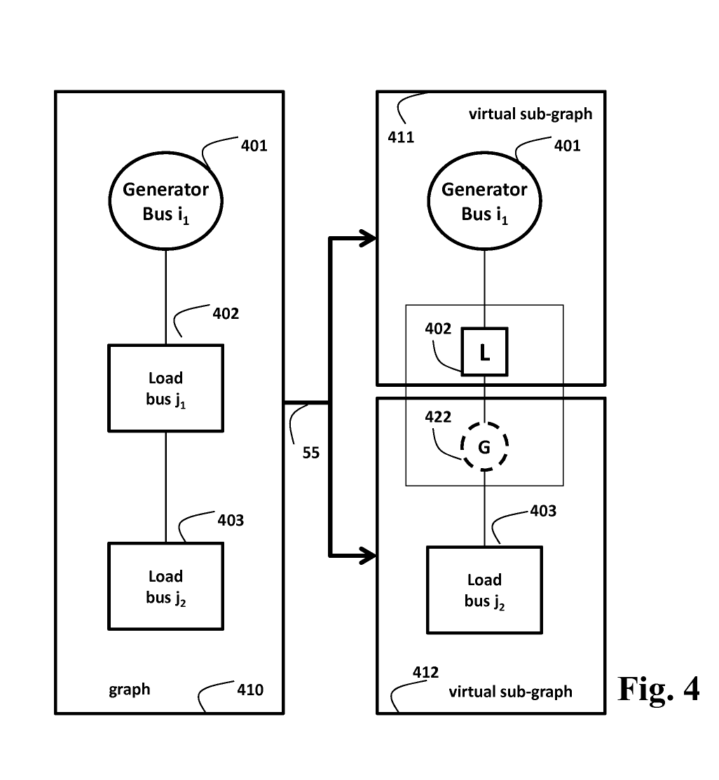

FIG. 4 shows a graph of a generator bus 401 connected to two load buses jᵢ 402 and j₂ 403. The graph is partitioned into virtual sub-graphs 411 and 412 where the load bus jᵢ 402 is now connected to the generator bus iₗ, and the virtual generator bus 422 with real and reactive power P_{i,v|(i,j}_{₁}₎^{D} and Q_{i,v|(i,j}_{₁}₎^{D} is connected to the load bus i₂. Accordingly, in the virtual sub-graph 412, virtual generation power terms P_{v,i}_{₂}_{|(i}_{₁}_{,i}_{₂}₎^{G}, Q_{v,i}_{₂}_{|(i}_{₁}_{,i}_{₂}₎^{G} are added to the bus j₁ such that Pⱼ_{₁}_{|(j}_{₁}_{,j}_{₂}₎^{G}=P_{i,v|(i,j}_{₁}₎^{D} and Qⱼ_{₁}_{|(j}_{₁}_{,j}_{₂}₎^{G}=Q_{i,v|(i,j}_{₁}₎^{D}.

Specifically, the power balance equations of the virtual sub-graph (i, jᵢ) can be expressed as

P_{i|(i,j}_{₁}₎^{G}−P_{i|(i,j}_{₁}₎^{D}=Re{|V_{i|(i,j}_{₁}₎|²y_{i,i}*/Nᵢ+V_{i|(i,j}_{₁}₎y_{i,j}_{₁}*(V_{i|i,j}_{₁}₎−Vⱼ_{₁}_{|(i,j}_{₁}₎)*}, (39)

Q_{i|(i,j}_{₁}₎^{G}−Q_{i|(i,j}_{₁}₎^{D}=Im{|V_{i|(i,j}_{₁}₎|²y_{i,i}*/Nᵢ+V_{i|(i,j}_{₁}₎y_{i,j}_{₁}*(V_{i|i,j}_{₁}₎−Vⱼ_{₁}_{|(i,j}_{₁}₎)*}, (40)

−Pⱼ_{₁}_{|(i,j}_{₁}₎^{D}−Pⱼ_{₁}_{|(i,j}_{₁}₎^{D}=Re{Vⱼ_{₁}_{|(i,j}_{₁}₎|²yⱼ_{₁}_{,j}_{₁}*/Nⱼ_{₁}+Vⱼ_{₁}_{|(i,j}_{₁}₎yⱼ_{₁}_{,i}*(Vⱼ_{₁}_{|(i,j}_{₁}₎−V_{i|(i,j}_{₁}₎)*}, (41)

−Qⱼ_{₁}_{|(i,j}_{₁}₎^{D}−Qⱼ_{₁}_{|(i,j}_{₁}₎^{D}=Im{Vⱼ_{₁}_{|(i,j}_{₁}₎|²yⱼ_{₁}_{,j}_{₁}*/Nⱼ_{₁}+Vⱼ_{₁}_{|(i,j}_{₁}₎yⱼ_{₁}_{,i}*(Vⱼ_{₁}_{|(i,j}_{₁}₎−V_{i|(i,j}_{₁}₎)*}. (42)

Sum of Flow Equation is Equivalent to Power Balance Equation

In a power grid, for each bus i, the sum of the flow equations in all virtual sub-graphs that contains the bus i, such as (i,j) and (j,i), is equivalent to the power balance equation of the bus i given that the conditions in equations (24-26) on the local variables hold.

Considering a simple example. Suppose all virtual sub-graphs contain a generator bus and a load bus. Suppose all generator buses serve as the generator bus in the virtual sub-graph. For each generator bus i, we can sum the flow equation of the generator bus over all adjacent buses j.

Σ_{j˜i}P_{i|(i,j)}^{G}−P_{i|(i,j)}^{D}=Σ_{j˜i}Re{|V_{i|(i,j)}|²yᵢᵢ*/Nᵢ+V_{i|(i,j)}yᵢⱼ*(V_{i|(i,j)}−V_{j|(i,j)})*}, (43)

Σ_{j˜i}Q_{i|(i,j)}^{G}−Q_{i|(i,j)}^{D}=Σ_{j˜i}Im{|V_{i|(i,j)}|²yᵢᵢ*/Nᵢ+V_{i|(i,j)}yᵢⱼ*(V_{i|(i,j)}−V_{j|(i,j)})*}. (44)

By the conditions in equations (24-26), we know that the sum of generation power P_{i,j}^{G} over all the virtual sub-graphs related to the bus i is equal to the original generation power of the bus i and so are all the other local variables. Thus, we can recover the power balance equation as follows

Pᵢ^{G}−Pᵢ^{D}=Re{|Vᵢ|²yᵢᵢ*+VᵢΣ_{i˜j}yᵢⱼ*(Vᵢ−Vⱼ)*}, (45)

Qᵢ^{G}−Qᵢ^{D}=Im{|Vᵢ|²yᵢᵢ*+VᵢΣ_{i˜j}yᵢⱼ*(Vᵢ−Vⱼ)*}. (46)

For the load bus j in the virtual sub-graph (i,j), the power balance equation can be recovered by summing the flow equations that appears in the all virtual sub-graphs (i,j) such that i-j. The sum of the equations is expressed as

Σ_{i˜j}−P_{i|(i,j)}^{D}=Σ_{i˜j}Re{|V_{i|(i,j)}|²yᵢᵢ*/Nⱼ+V_{i|(i,j)}yᵢⱼ*(V_{i|(i,j)}−V_{j|(i,j)})*}, (47)

Σ_{i˜j}−Q_{i|(i,j)}^{D}=Σ_{i˜j}Im{|V_{i|(i,j)}|²yᵢᵢ*/Nⱼ+V_{i|(i,j)}yᵢⱼ*(V_{i|(i,j)}−V_{j|(i,j)})*}. (48)

For the virtual sub-graph with two load buses, one of the load two buses has additional virtual generation power and this additional power is canceled by the term added to the virtual sub-graph with a real generator bus. Consider the buses jᵢ in a virtual sub-graph with (j₁, j₂) being both load buses. The bus j₁ is also in the virtual sub-graph (i, jᵢ), where bus i is a generator bus. Then, the flow equation of bus jᵢ in the virtual sub-graph (jᵢ, j₂) is expressed as

Pⱼ_{₁}_{|(j}_{₁}_{,j}_{₂}₎^{G}−Pⱼ_{₁}_{|(j}_{₁}_{,j}_{₂}₎^{D}=Re{|Vⱼ_{₁}_{|(j}_{₁}_{,j}_{₂}₎|²yⱼ_{₁}_{,j}_{₁}*/Nⱼ_{₁}+Vⱼ_{₁}_{|(j}_{₁}_{,j}_{₂}₎yⱼ_{₁}_{,j}_{₂}*(Vⱼ_{₁}_{|(j}_{₁}_{,j}_{₂}₎−Vⱼ_{₂}_{|(j}_{₁}_{,j}_{₂}₎)*}, (49)

Qⱼ_{₁}_{|(j}_{₁}_{,j}_{₂}₎^{G}−Qⱼ_{₁}_{|(j}_{₁}_{,j}_{₂}₎^{D}=Im{|Vⱼ_{₁}_{|(j}_{₁}_{,j}_{₂}₎|²yⱼ_{₁}_{,j}_{₁}*/Nⱼ_{₁}+Vⱼ_{₁}_{|(j}_{₁}_{,j}_{₂}₎yⱼ_{₁}_{,j}_{₂}*(Vⱼ_{₁}_{|(j}_{₁}_{,j}_{₂}₎−Vⱼ_{₂}_{|(j}_{₁}_{,j}_{₂}₎)*}. (50)

Accordingly, in the virtual sub-graph (i, jᵢ), the flow equation of bus jᵢ is

−Pⱼ_{₁}_{|(i,j}_{₁}₎^{D}−Pⱼ_{₁}_{|(i,j}_{₁}₎^{D}=Re{|Vⱼ_{₁}_{|(i,j}_{₁}₎|²yⱼ_{₁}_{,j}_{₁}*/Nⱼ_{₁}+Vⱼ_{₁}_{|(i,j}_{₁}₎yⱼ_{₁}_{,i}*(Vⱼ_{₁}_{|(i,j}_{₁}₎−V_{i|(i,j}_{₁}₎)*}, (51)

−Qⱼ_{₁}_{|(i,j}_{₁}₎^{D}−Qⱼ_{₁}_{|(i,j}_{₁}₎^{D}=Im{|Vⱼ_{₁}_{|(i,j}_{₁}₎|²yⱼ_{₁}_{,j}_{₁}*/Nⱼ_{₁}+Vⱼ_{₁}_{|(i,j}_{₁}₎yⱼ_{₁}ᵢ*(Vⱼ_{₁}_{|(i,j}_{₁}₎−V_{i|(i,j}_{₁}₎)*}. (52)

Because we impose that Pⱼ_{₁}_{,i}^{D}=Pⱼ_{₁}_{,j}_{₂}^{G}, when all flow equations about the bus jᵢ is summed up, the term Pⱼ_{₁}_{,j}_{₂}^{G} is canceled out. This ensures that the sum of the flow equation is equivalent to the power balance equation of the loads.

Consensus Method for Local Estimates in the Virtual Sub-Graph Approach

Each virtual sub-graph is an independent agent in the distributed optimization. The exchange and update of the consensus variables is performed as described above with the consensus filter. Note that in this embodiment, each virtual sub-graph (i,j) has the values of the voltages of bus i and j. However, because the bus i may be associated with more than one virtual sub-graphs, the value of voltage v_{i|(i,j)} must be compatible to the voltages at other buses. The same consistency requirements are also imposed on the value of the generation power and the load power. Those relationships are enforced by equations (24-26), which are necessary to obtain a feasible solution to the global problem.

In order to meet such requirements, each virtual sub-graph (i,j) maintains an estimates of the bus i's voltage, power generation and load of other virtual sub-graphs (i,j′),j′≠j,j′˜i. Accordingly, The generation powers of i in the virtual sub-graph (i,j′) estimated by virtual sub-graph (i,j) are expressed as (P^{G})_{i|(i,j′)}^{(i,j)}, (Q^{G})_{i|(i,j′)}^{(i,j)}, and the load estimates are (P^{D})_{i|(i,j′)}^{(i,j)}, (Q^{D})_{i|(i,j′)}^{(i,j)}.

For virtual sub-graphs sharing the bus i with the virtual sub-graph (i,j), the consensus variables for each estimate are [symbol] _{i|(i,j′)}^{(i,j)}, [symbol] _{i|(i,j′)}^{(i,j)}, [symbol] _{i|(i,j′)}^{(i,j)}, [symbol] _{i|(i,j′)}^{(i,j)}, \hat{V}_{i|(i,j′)}^{(i,j)}. The consensus variables are updated according to the following rules

[symbol]

_{i|(i,j′)}^{(i,j)}(k+1)= [symbol] _{i|(i,j′)}^{(i,j)}(k)+γ(P_{i|(i,j′)}^{G}(k)− [symbol] _{i|(i,j′)}^{(i,j)}(k)),

[symbol]

_{i|(i,j′)}^{(i,j)}(k+1)= [symbol] _{i|(i,j′)}^{(i,j)}(k)+γ(Q_{i|(i,j′)}^{G}(k)− [symbol] _{i|(i,j′)}^{(i,j)}(k),

[symbol]

_{i|(i,j′)}^{(i,j)}(k+1)= [symbol] _{i|(i,j′)}^{(i,j)}(k)+γ(P_{i|(i,j′)}^{D}(k)− [symbol] _{i|(i,j′)}^{(i,j)}(k)),

[symbol]

_{i|(i,j′)}^{(i,j)}(k+1)= [symbol] _{i|(i,j′)}^{(i,j)}(k)+γ(Q_{i|(i,j′)}^{D}(k)− [symbol] _{i|(i,j′)}^{(i,j)}(k),

ê_{i|(i,j)}(k+1)=ê_{i|(i,j)}(k)+γΣ_{j′˜i}(e_{i|(i,j′)}(k)−ê_{i|(i,j)}(k)), and

\hat{f}_{i|(i,j)}(k+1)=\hat{f}_{i|(i,j)}(k)+γΣ_{j′˜i}(f_{i|(i,j′)}(k)−\hat{f}_{i|(i,j)}(k)). (53)

where the constant 0<γ<1 is the consensus gain which can be selected properly to ensure the convergence of the consensus algorithm. The consensus process communicates with other virtual sub-graphs to exchange the consensus variables.

Local Optimization Problem

Similar to the direct approach, a local optimization problem is formulated for each virtual sub-graph to minimize the power generation cost and the estimation error. Without loss of generality, we consider the virtual sub-graph (i,j) with bus i and j that also appear in other virtual sub-graphs. The local optimization problem can be expressed as the following objective function:

$$\begin{matrix}{min}_{{P}_{i \vert ( i , j )}^{G} , {Q}_{i \vert ( i , j )}^{G} , {e}_{i \vert ( i , j )} , {f}_{i \vert ( i , j )} , {e}_{j \vert ( i , j )} , {f}_{j \vert ( i , j )}} {F}_{i} ( {P}_{i}^{G} ) + {ρ}_{i} {Σ}_{k ∼ i , k \neq j} ( {‖ {( {P}^{G} )}_{i \vert ( i , k )}^{( i , j )} - {i \vert ( i , k )}_{( i , j )}^{} ‖}^{2} + {‖ {( {Q}^{G} )}_{i \vert ( i , k )}^{( i , j )} - {i \vert ( i , k )}_{( i , j )}^{} ‖}^{2} + {‖ {( {P}^{D} )}_{i \vert ( i , k )}^{( i , j )} - {i \vert ( i , k )}_{( i , j )}^{} ‖}^{2} + {‖ {( {Q}^{D} )}_{i \vert ( i , k )}^{( i , k )} - {i \vert ( i , k )}_{( i , j )}^{} ‖}^{2} ) + {ρ}_{i} {Σ}_{k ∼ j , k \neq i} ( {‖ {( {P}^{G} )}_{j \vert ( k , j )}^{( i , j )} - {j \vert ( k , j )}_{( i , j )}^{} ‖}^{2} + {‖ {( {Q}^{G} )}_{j \vert ( k , j )}^{( i , j )} - {j \vert ( k , j )}_{( i , j )}^{} ‖}^{2} + {‖ {( {P}^{D} )}_{j \vert ( k , j )}^{( i , j )} - {j \vert ( k , j )}_{( i , j )}^{} ‖}^{2} + {‖ {( {Q}^{D} )}_{j \vert ( k , j )}^{( i , j )} - {j \vert ( k , j )}_{( i , j )}^{} ‖}^{2} ) + {ρ}_{j} ( {‖ {e}_{j \vert ( i , j )} - {\hat{e}}_{j \vert ( i , j )} ‖}^{2} + {‖ {f}_{j \vert ( i , j )} - {\hat{f}}_{j \vert ( i , j )} ‖}^{2} + {ρ}_{i} ( {‖ {e}_{i \vert ( i , j )} - {\hat{e}}_{i \vert ( i , j )} ‖}^{2} + {‖ {f}_{i \vert ( i , j )} - {\hat{f}}_{i \vert ( i , j )} ‖}^{2} & ( 54 ) \\ {P}_{i \vert ( i , j )}^{G} - {P}_{i \vert ( i , j )}^{D} = Re \{ {\vert {V}_{i \vert ( i , j )} \vert}^{2} {y}_{ii}^{*} + {V}_{i \vert ( i , j )} {{y}_{ij}^{*} ( {V}_{i \vert ( i , j )} - {V}_{j \vert ( i , j )} )}^{*} \} , & ( 55 ) \\ {Q}_{i \vert ( i , j )}^{G} - {Q}_{i \vert ( i , j )}^{D} = Im \{ {\vert {V}_{i \vert ( i , j )} \vert}^{2} {y}_{ii}^{*} + {V}_{i \vert ( i , j )} {{y}_{ij}^{*} ( {V}_{i \vert ( i , j )} - {V}_{j \vert ( i , j )} )}^{*} \} , & ( 56 ) \\ {P}_{j \vert ( i , j )}^{G} - {P}_{j \vert ( i , j )}^{D} = Re \{ {\vert {V}_{j \vert ( i , j )} \vert}^{2} {y}_{jj}^{*} + {V}_{j \vert ( i , j )} {{y}_{ij}^{*} ( {V}_{j \vert ( i , j )} - {V}_{i \vert ( i , j )} )}^{*} \} , & ( 57 ) \\ {Q}_{j \vert ( i , j )}^{G} - {Q}_{j \vert ( i , j )}^{D} = Im \{ {\vert {V}_{j \vert ( i , j )} \vert}^{2} {y}_{jj}^{*} + {V}_{j \vert ( i , j )} {{y}_{ij}^{*} ( {V}_{j \vert ( i , j )} - {V}_{i \vert ( i , j )} )}^{*} \} , & ( 58 ) \\ \underline{{V}_{i}} \leq {e}_{i \vert ( i , j )}^{2} + {f}_{i \vert ( i , j )}^{2} \leq {\overline{V}}_{i} , & ( 59 ) \\ {\underline{P}}_{i}^{G} \leq {P}_{i \vert i , j}^{G} + {{Σ}_{k ∼ i} ( {P}^{G} )}_{i \vert i , k}^{( i , j )} \leq {\overline{P}}_{i}^{G} , {\underline{Q}}_{i}^{G} \leq {Q}_{i \vert i , j}^{G} + {{Σ}_{k ∼ i} ( {Q}^{G} )}_{i \vert i , k}^{( i , j )} \leq {\overline{Q}}_{i}^{G} . & ( 60 ) \\ {P}_{i \vert i , j}^{D} + {{Σ}_{k ∼ i} ( {P}^{D} )}_{i \vert i , k}^{( i , j )} = {P}_{i}^{D} , {Q}_{i \vert i , j}^{D} + {{Σ}_{k ∼ i} ( {Q}^{D} )}_{i \vert i , k}^{i , j} = {Q}_{i}^{D} . & ( 61 ) \\ {\underline{P}}_{j}^{G} \leq {P}_{j \vert i , j}^{G} + {{Σ}_{k ∼ j} ( {P}^{G} )}_{j \vert k , j}^{i , j} \leq {\overline{P}}_{j}^{G} , {\underline{Q}}_{j}^{G} \leq {Q}_{j \vert i , j}^{G} + {{Σ}_{k ∼ j} ( {Q}^{G} )}_{j \vert k , j}^{i , j} \leq {\overline{Q}}_{j}^{G} . & ( 62 ) \\ {P}_{j \vert i , j}^{D} + {{Σ}_{k ∼ j} ( {P}^{D} )}_{j \vert k , j}^{( i , j )} = {P}_{j}^{D} , {Q}_{j \vert k , j}^{D} + {{Σ}_{k ∼ j} ( {Q}^{D} )}_{j \vert k , j}^{( i , j )} = {Q}_{j}^{D} . & ( 63 )\end{matrix}$$

The local optimization problem within each virtual sub-graph is for two buses. The number of adjacent virtual sub-graphs of each virtual sub-graphs is equal to the number of adjacent buses i and j within the virtual sub-graph. Thus, this is a small scale OPF problem and can be solved by available nonlinear optimization solvers like fmincon and IPOPT efficiently.

(1) initialize the values of P_{k|(i,j)}^{G}(0), Q_{k|(i,j)}^{G}(0), P_{k|(i,j)}^{D}(0), Q_{k|(i,j)}^{D}(0), e_{k|(i,j)}(0), f_{k|(i,j)}(0), k=i, j as well as the estimation variables (P^{G})_{i|(i,j′)}^{(i,j)}(0), (Q^{G})_{i|(i,j′)}^{(i,j)}(0), (P^{D})_{i|(i,j′)}^{(i,j)}(0), (Q^{D})_{i|(i,j′)}^{(i,j)}(0), e_{i|(i,j)}^{(i,j′)}(0), f_{i|(i,j′)}^{(i,j)}(0), k=i,j and consensus variables.

(2) At iteration k+1, if a termination condition, such as maximum iteration number or the error tolerance on the estimation, is reached, then the method terminates. If not, each agent transmits the local variables to adjacent virtual sub-graphs.

(3) Update the consensus variables [symbol] _{i|(i,j′)}^{(i,j)}, [symbol] _{i|(i,j′)}^{(i,j)}, [symbol] _{i|(i,j′)}^{(i,j)}, ê_{i|(i,j)}, \hat{f}_{i|(i,j)} according to (53).

(4) Update the decision variables by solving the optimization problem (54), and then go to step (2).

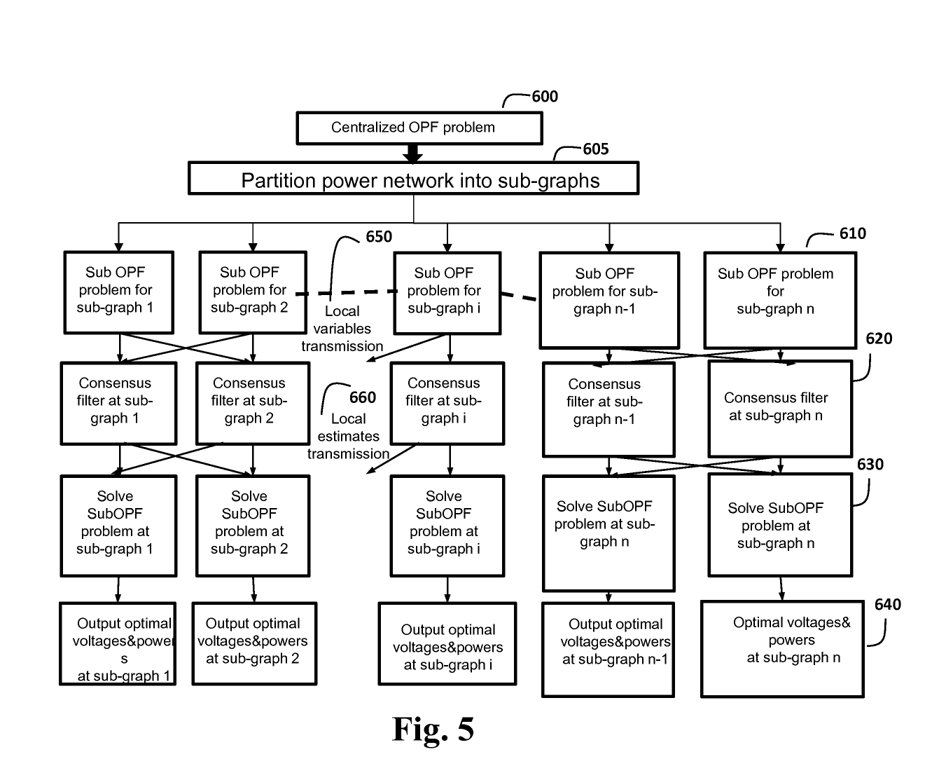

FIG. 5 is a block diagram of the general case of solving a decentralized OPF problem that associates each bus with a local OPF subproblem using a direct approach according to embodiments of the invention. The OPF problem 600 is partitioned 605 into sub OPF problems 610, one for each virtual sub-graph 1, 2, . . . , n−1, n. Then, for each subproblem 610 of each virtual sub-graph, the following steps are iterated until a termination condition is reach. A consensus filter 620 is applied at each virtual sub-graph to update the conscensus variables êⱼ₍ᵢ₎ and \hat{f}ⱼ₍ᵢ₎. The subOPF problem is solved 630 for each virtual sub-graph to update the decision variables Pᵢ^{G}, Qᵢ^{G}, eᵢ, fᵢ. Then, at termination, output 640 the optimal voltage and power for each virtual sub-graph.

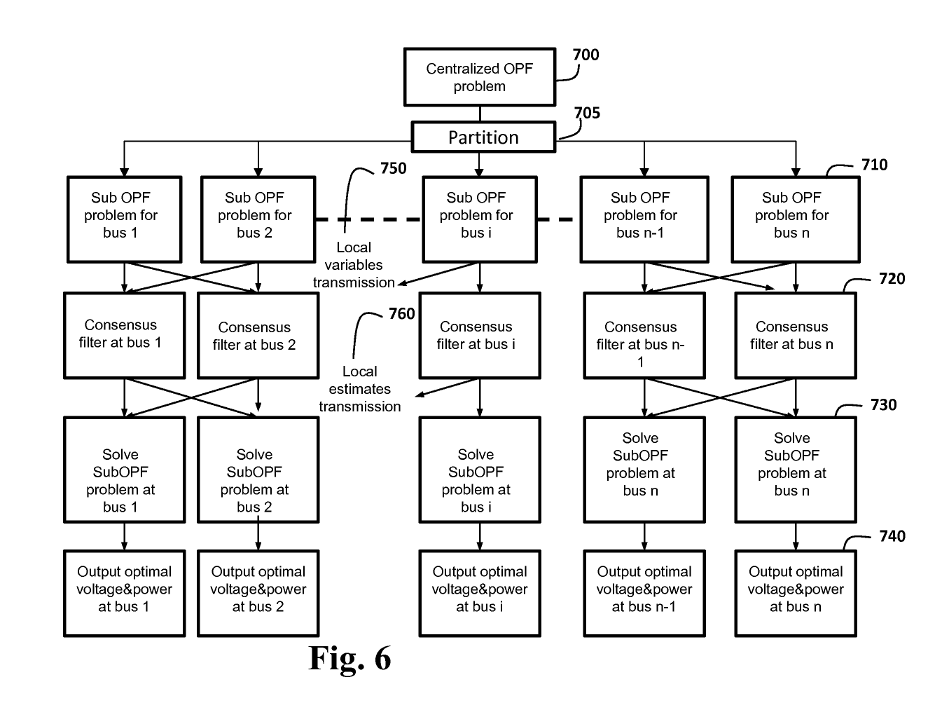

FIG. 6 is a block diagram of the specific case of solving a decentralized OPF problem that associates each bus with a local OPF subproblem using a direct approach according to embodiments of the invention. The OPF problem 600 is partitioned 705 into sub OPF problems 710, one for each bus 1, 2, . . . , n−1, n. Then, for each subproblem, the following steps are iterated until a termination condition is reach. A consensus filter 720 is applied to update the conscensus variables êⱼ₍ᵢ₎ and \hat{f}ⱼ₍ᵢ₎. The subOPF problem is solved 730 to update the local decision variables Pᵢ^{G}, Qᵢ^{G}, eᵢ, fᵢ. Then, at termination, output 740 the optimal voltage and power for each bus.

### EFFECT OF THE INVENTION

The embodiments provide a consensus-based distributed optimization method. The method can be used to solve optimal power flow problem. The method is performed in multiple agents that communicate with each other in a distributed manner. Two implementation are described. In a direct approach, each bus is associated with an agent. Each agent solve a local OPF problem under the constraint of a power balance equation of the associated bus. The agent estimates the voltages of adjacent agents and exchanges consensus variables with other agents to reach consensus. A consensus filtering method is used to ensure convergence of the estimation. In a virtual sub-graphs approach, each virtual sub-graph is concerned with a branch flow between adjacent buses. This approach is more effective in the case that multiple loads are connected to a generator bus. The consensus are reached for all variables.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for estimating optimal power flows (OPF) in a power grid, wherein the power grid includes generators and loads connected by buses, comprising steps:
representing the power grid as a graph partitioned into virtual sub-graphs, wherein each virtual sub-graphs includes at least one generator, and load and one bus;
associating an agent with each virtual sub-graph, wherein the agent includes computation and communication capabilities;
measuring local variables and obtaining consensus variables (CV) in each virtual sub-graph by the agent, wherein the local and consensus variables include voltage and power variables subject to power balance constraints in the virtual sub-graph;
exchanging and updating the CV of adjacent virtual sub-graphs using the agents;
solving an OPF problem for each virtual sub-graph using the agent based on the measured local variables and the exchanged consensus variables;
iterating the exchanging and the solving until a termination condition is satisfied; and
outputting the optimal OPF for each virtual sub-graph.

2. The method of claim 1, wherein each agent includes computation and communication capabilities and a memory.

3. The method of claim 2, further comprising:
storing the graph and sub-graphs in the memory.

4. The method of claim 1, wherein vertices in the sub-graphs represent virtual generators and virtual loads.

5. The method of claim 1, wherein the OPF problem is
$${min}_{{P}_{i}^{G} , {Q}_{i}^{G} , {e}_{i} , {f}_{i} , i ∈ 𝒩} {Σ}_{i ∈ {𝒩}^{G}} {F}_{i} ( {P}_{i}^{G} ) ,$$
wherein active and reactive generation power at bus i are Pᵢ^{G} and Qᵢ^{G}, a complex voltage of bus i is Vᵢ=eᵢ+jfᵢ with eᵢ being a real part of the voltage, fᵢ an imaginary part, and j=\sqrt{−1}, and Pᵢ^{G}, Qᵢ^{G}, eᵢ, fᵢ are the local variables.

6. The method of claim 1, wherein the OPF problem is nonconvex due to quadratic relations between voltages of adjacent buses.

7. The method of claim 1, further comprising:
penalizing deviations between the local variables and the consensus variables using a penalty function.

8. The method of claim 1, wherein the updating uses a consensus filter.

9. The method of claim 1, wherein the exchanging only occurs among adjacent buses.

10. The method of claim 7 wherein the penalty function is formulated using an 1-norm.

11. The method of claim 1, wherein each virtual sub-graphs includes only one bus.

12. The method of claim 1, wherein each virtual sub-graphs includes two buses.

13. The method of claim 12, wherein the two buses are a generator bus and a load bus.

14. The method of claim 12, wherein the two buses are generator buses.

15. The method of claim 12, wherein the two buses are load buses.

16. The method of claim 15, wherein the one of the load buses is represented in the sub-graph as a real load bus and a virtual generator bus.
